(19) United States
(12) Patent Application Publication
(10) Pub. No.: US 2004/0201188 A1
(43) Pub. Date: Oct. 14, 2004

(54) Luggage, computer case or the like, having shock absorbing quiet operating elastomeric wheels filled with compressible material

(76) Inventors: Bernard D Sadow, Chappaqua, NY (US); Brian D Sadow, Danbury, CT (US)

Correspondence Address: Abelman Frayne & Schwab, 150 East 42nd Street, New York, NY, 10017-5612, US

(21) Appl. No.: 10/479,290

(22) PCT Filed: May 24, 2002
(86) PCT No.: PCT/US02/17020

Related U.S. Application Data
(60) Provisional application No. 60/293,610, filed on May 25, 2001.
(60) Provisional application No. 60/304,626, filed on Jul. 11, 2001.

(51) Int. Cl. B62B 1/00

(52) U.S. Cl. 280/47.26

(57) ABSTRACT

A mobile article carrier is disclosed for transporting articles wherein the article carrier is movably supported by at least a pair of rotatably mounted wheels, each wheel including an elastomeric synthetic or natural rubber tire shell filled with a compressible material to promote relatively cushioned quiet transport of the article carrier over hard and irregular surfaces, with effective shock absorption. In one embodiment the wheels are pneumatically filled with air at one atmosphere or air under pressure. The article carrier contemplated is an article of luggage, computer case, or the like, which may be directly or indirectly supported by at least one axle which is in turn, supported on the rotatable wheels. In another embodiment the tire shells are filled with a natural or synthetic rubber or combinations thereof, of predetermined resilient compressible character to provide shock absorption and quiet operation of the wheels over hard irregular surfaces. In still another embodiment the tire shells are filled with a resilient compressible foam rubber, polyurethane foam, or gel material or the like of predetermined hardness to promote shock absorption and quiet rolling operation over hard continuous or uneven surfaces. Although the tire shells are preferably rotationally molded of PVC, they may be otherwise molded of PVC combined with other synthetic rubber or natural rubber compounds. The wheels preferably are supported on ball bearing units to promote smooth rolling operation. Alternatively they may be directly supported on hubs and central axles without the use of bearing units. Variations in the wall thickness of the tire shells and the air pressure in the tire shells permit variations in the cushioning and shock absorption characteristics.

### BACKGROUND OF THE INVENTION

1. Field of the Invention

Wheeled luggage, computer cases, or the like are disclosed, particularly for carrying articles such as personal items including clothing or the like, or instrumentation such as computers or the like. The luggage is provided with resilient elastomeric, at least partially pneumatically supported wheels to promote shock absorption and quiet operation.

2. Description of the Related Art

A variety of wheeled luggage, article carriers or the like are generally known to minimize the amount of effort required by a user to transport relatively heavy articles. In particular the article carriers which are primarily contemplated include wheeled luggage for carrying personal articles such as clothing or the like, or computer cases for carrying computers or other delicate instrumentation. In such carriers the device is normally supported for mobile transport by rotatably mounted wheels which are generally mounted on one or more axles mounted directly or indirectly to the luggage. In most instances the wheels are made of a durable relatively hard plastic material to withstand the rigors of motion over different types of surfaces, including pavements, curbstones, cement, concrete or the like. In general, movement of such wheeled devices having relatively hard and rigid wheels over such surfaces has been found to be noisy due to the interaction between the relatively rigid wheels and the surfaces, as well as to promote undue shock to the contents which are being carried. In particular in the instance where a delicate instrument such as a computer is being carried in a computer case, permanent damage to the computer can be caused by shock and the rigid wheels can have a deleterious affect, particularly if the case travels over curbs.

In some instances hard plastic wheels have been replaced by other, relatively solid materials also having a minimum amount of flexibility. As a consequence the limited flexibility, or “give” of the material has continued to produce both undesirable noises and transmit undue shock to the contents being transported by the carrier. Even in instances where shock and potential damage is not of great significance or where the noise factor is not of great significance, the hardness of the wheels often can cause excessive wear to surfaces.

We have invented wheeled luggage which utilizes flexible and resilient elastomeric wheels which provide substantial cushioning when being transported over relatively hard and irregular surfaces and which overcomes the deficiencies of these prior devices.

### SUMMARY OF THE INVENTION

An article carrier is supported on at least two rotatably mounted wheels, each wheel comprising an elastomeric tire shell filled with a compressible material which permits resilient flexing of the outer tire shell when the tire shell is rolled over relatively hard surfaces and engages relatively uneven abutments or the like. Preferably the compressible material is air or other gas under one atmosphere pressure, or greater. Each tire shell includes a valve device for introducing the air under pressure into a space defined by the tire shell. Alternatively, each tire shell may be filled with a resilient compressible elastomeric material such as a foam rubber or gel.

Each tire shell is preferably rotationally or centrifugally molded of a resilient synthetic or natural rubber material or combinations thereof, preferably polyvinyl chloride (PVC). Each tire shell is rotatably supported on a hub to comprise a wheel, with each wheel being supported on at least one axle, the axle supporting article carrier by the wheels. Preferably each wheel is supported on the same axle and the article carrier is an article of luggage, a computer case, or the like.

A wheel is disclosed for supporting an article carrier such as an article of luggage, which comprises a rotationally molded elastomeric tire shell having an annular internal space filled with air at one atmosphere, the shell being securely mounted on a hub, the hub being comprised of two halves. A first hub half is inserted into a central opening of the tire shell from one side, and a second hub half is inserted into the central opening from the other side. Means is provided to secure the hub halves together in a manner to grip the tire shell so as to be fixed for rotation therewith. The means to secure the hub halves together preferably comprises a plurality of threaded fasteners such as screws or bolts and nuts arranged in a circular array and extending from one of the hub halves to the other. Also, preferably the means to secure the hub halves together comprises a plurality of resilient extension fingers extending from one of the hub halves and having lock tabs at their free ends. The fingers are adapted to be inserted into corresponding spaces in the other hub half to resiliently engage the other hub half in snap-action to retain said hub halves together. Further, means is provided on the tire shell to be gripped by the hub halves to retain the hub halves in fixed assembled relation with the tire shell.

The tire shell further comprises an internal radially extending flange formed integral with the tire shell.

A wheel is disclosed for supporting an article of luggage, which comprises a tire shell rotationally molded of polyvinyl chloride, the tire shell having an internal annular space filled with air, a hub including two hub halves. A first half has elongated resilient fingers adapted to be attached to a second hub half by resilient snap action. The hub has a central opening for reception of an axle to be positioned centrally of the hub to rotatably support the hub and the tire shell on an article of luggage. The hub halves and the resilient fingers are preferably molded of nylon or other resilient material.

A wheel is also disclosed for supporting an article of luggage, which comprises a tire shell rotationally molded polyvinyl chloride, the shell having an internal annular space filled with air. A hub includes two hub halves, a first half being attached to a second hub half by a plurality of threaded fasteners. The hub halves have a central opening for reception of an axle to be positioned centrally of the hub to rotatably support the hub and the tire shell on an article of luggage. The threaded fasteners are screws or bolts attached by nuts.

### BRIEF DESCRIPTION OF THE DRAWINGS

Preferred embodiments of the invention are described hereinbelow with reference to the drawings, wherein:

FIG. 1 is a side elevational view of wheeled luggage supported on rotatably mounted at least partially pneumatically supported elastomeric wheels having cushion-like resilient properties;

FIG. 2 is a side elevational view of the wheeled luggage of FIG. 1, illustrating the flexible cushion-like property of the elastomeric wheels when they come into engagement with a step or other abutment;

FIG. 3 is a cross-sectional view taken along lines 3-3 of FIG. 1, of the wheel shown in FIG. 1 including an air inflating valve;

FIG. 4 is a cross-sectional view of an alternative embodiment of a wheel similar to the wheel of FIGS. 1 and 3, constructed either of a molded outer casing of elastomeric material filled with atmospheric air, either under atmospheric pressure or under pressure greater than one atmosphere, or alternatively, filled with an elastomeric resilient material;

FIG. 5 is a cross-sectional view of an alternative embodiment of a wheel of the invention, having a molded elastomeric shell with foam rubber or gel fill in place of the air and the elastomeric resilient filler material of FIGS. 3 and 4;

FIG. 6 is a cross-sectional view of a pneumatically filled elastomeric tire shell which is preferably rotationally or otherwise molded or fabricated, and provided with a two-part hub which houses a pair of ball bearing units to promote shock absorbing, smooth and quiet operation over all types of terrain;

FIG. 7 is a cross-sectional view of an alternative embodiment of the wheel of FIG. 6, incorporating a pair of central hubs, dimensioned and adapted to fit one inside the other, preferably by press fitting;

FIG. 8 is a cross-sectional view of an alternative embodiment of a wheel similar to the wheel of FIG. 7, wherein the central hubs are made to be press or friction fitted with respect to the molded outer tire shell and are in end-to-end relation in the center of the shell;

FIG. 9 is a cross-sectional view of yet another alternative embodiment of a wheel similar to the wheels of the previous embodiments, wherein a two part hub is provided, both parts being attached to each other by screws or bolts and nuts, and the hub halves configured to grip a downwardly extending flange which is formed as part of the tire shell;

FIG. 10 is a perspective view of an alternative embodiment of a two part hub, one part having extended snap fingers which are adapted to be received by the other part to retain the hub halves together by resilient snap-action; and

FIG. 11 is a cross-sectional view of a tire shell similar to the tire shells of FIGS. 8 and 9, mounted on the hub of FIG. 10, and supported on suitable ball bearing units.

### DETAILED DESCRIPTION OF THE INVENTION

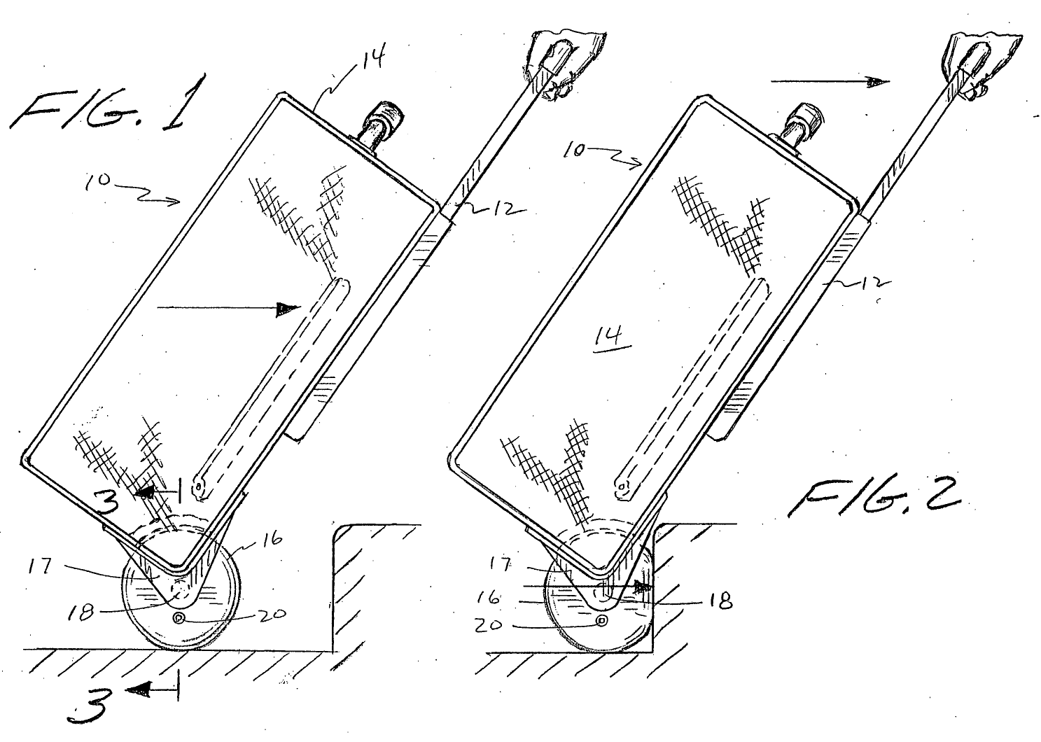

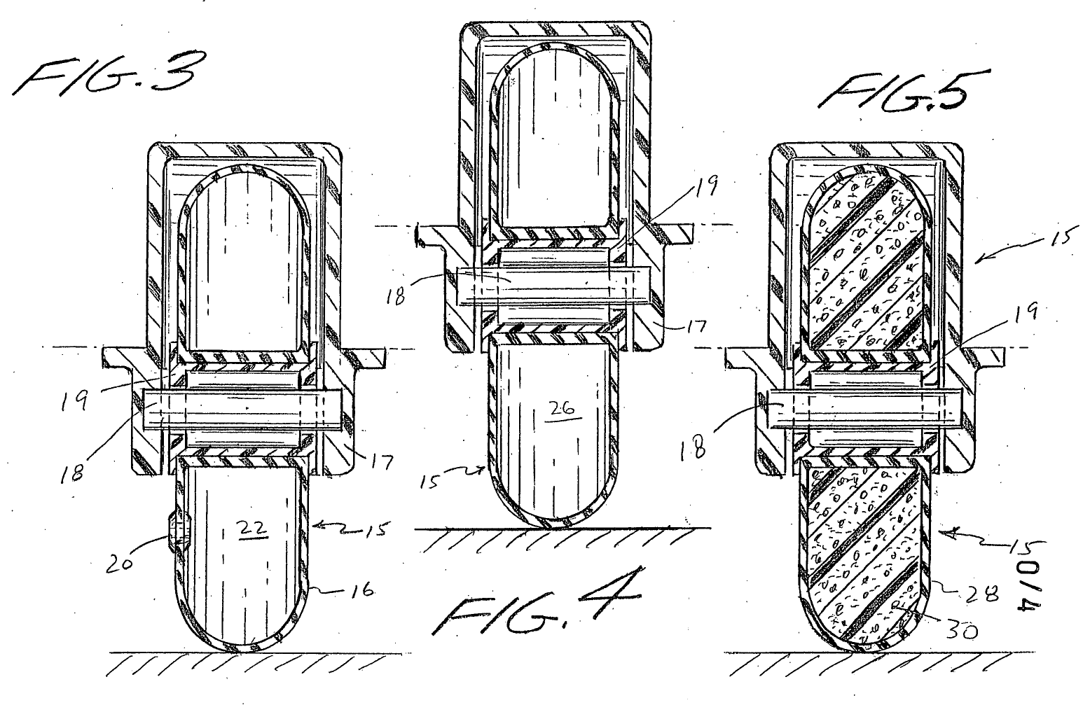

Referring initially to FIG. 1 there is illustrated an article carrying container 10 in the form of a piece of luggage 14 having support handle 12 attached thereto for directing the container 10 from place to place. Container 10 is directly supported on rotatably mounted pneumatically (air, gas or the like) filled tire shells 16 which are supported on axle 18 extending through support brackets 17 attached to container 10. The tire shells 16 are supported at least in part and are preferably rotationally molded of polyvinyl chloride (hereinafter PVC) or combinations of PVC and natural or other synthetic rubber compounds resulting in an elastomeric, i.e. material having the ability to deform and which has a natural tendency to recover both due to the nature of the material alone or in combination with a contained pneumatic substance. The tire shells 16 may be alternatively centrifugally or otherwise molded of natural or synthetic rubbers, or combinations or compounds thereof. As noted, the tires are pneumatically supported by air, gas or the like, through pneumatic valve 20 shown in the side of tire shells 16 in FIG. 3. The tire shells 16 are mounted on nylon hubs 19 as will be described hereinbelow, to form fully supported wheels 15 as shown in FIGS. 2-5.

As can be seen in FIG. 2, the article carrying container 10 is shown while being transported by a user with the wheels in forceful engagement with a step or other abutment, whereby the wheels are adapted to be compressed to thereby absorb a significant amount of the shock which the container 10 would otherwise be subjected to if tire shells 16 were made of a conventional hard and durable plastic or other non elastomeric rigid material as is known in the art.

Referring now to FIG. 3, there is shown a cross-sectional view of the wheel 15 of FIG. 1, wherein tire shell 16 is rotatably mounted on axle 18 and is molded to include annular space 22 which is filled with air (or alternatively, other gaseous medium) via valve 20. The device which may be used to introduce air under pressure into the space 22 of tire shells 16 through valve 20 may be a bicycle or automobile air pump, or alternatively, it may be a pump of the type used for filling sports articles such as footballs, basketballs or the like with a well known adapter. The tire shells 16 of the wheel 15 may be of the same elastomeric synthetic or natural rubber or combinations thereof, which are used for bicycle or automobile tires, and the valve 20 may be of the same type used for such sports related articles such as footballs, basketballs or the like. The air is introduced into the tire 16 under pressure and the pressure may be varied in accordance with the shock absorption desired, which is in turn dependent upon the level of delicate handling required for a particular device which is intended to be transported. For example, if less shock absorption is required or greater weight is to be transported, a higher air pressure may be utilized, whereas if more shock absorption is required, a lower air pressure may be utilized.

It has been found that with the tires shown in FIGS. 1 and 3, the article carrier can be used to transport relatively delicate articles over relatively complex and uneven surfaces with a minimum amount of shock being transmitted to the articles. Furthermore, it has been found that the tires have the benefit of significantly reducing the noise generated between the wheel and the hard surfaces over which such carriers are generally transported due to the cushioned nature of the elastomeric outer casing of the wheels combined with the resilience provided by the air contained therein.

Referring now to FIG. 4, there is shown an alternative embodiment of the invention wherein an elastomeric tire shell 24 is rotationally molded of PVC or combinations of PVC and natural or other synthetic rubbers or compatible known compounds. The shell 24 includes annular space 26 which is filled with air under atmospheric pressure. The atmospheric air is retained in the tire shell 24 during the molding process, which may also be a centrifugal or other types of molding processes. In a rotational or centrifugal molding process, the internal space being formed is made to retain the atmospheric air at one atmosphere pressure, thus dispensing with the need to provide an inflation valve.

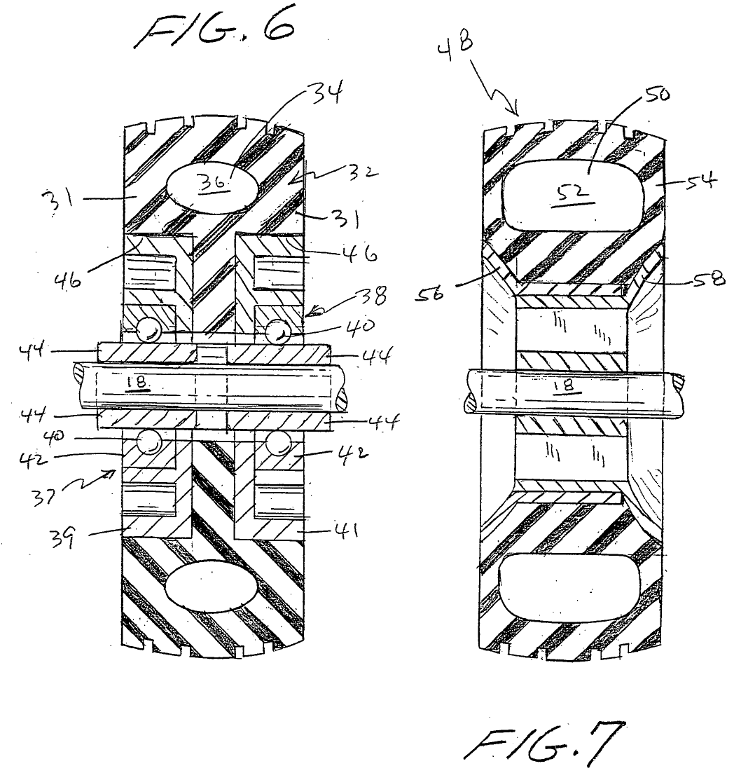

In such instance, as in the tire shell 24 of FIGS. 4, since atmospheric pressure is relatively low in comparison to the pressure in the tires of FIGS. 1 and 3, the shock absorption and resilience of the air filled tire can be supplemented by controlling the durometer of the material from which the tire shell is molded. Furthermore, the thickness of the walls of the tire shell can also be adjusted to control the stiffness of the tire in a manner to supplement the cushioning effect of the air under atmospheric pressure to produce the desired result. For example, the walls of the tire shell can be made thicker as shown in FIGS. 6-9, the thickness being determined by the degree of resilience and shock absorption which would be desired.

Alternatively a resilient elastomeric material (not shown) of a similar or identical type as the material which is utilized to form the outer tire shell 24 may be used to fill the tire shell 24 shown in FIG. 4. Still, alternatively, a gel-type resilient material may be used to fill the shell 24. As noted above, where atmospheric air fills the tire shell of FIG. 4, the air may be introduced during manufacture of the shell. Where an elastomeric filler material is used, the elastomeric filler material may be of a predetermined durometer—or hardness—which may be selected for the purpose of providing relatively shock free transport of the article carrier over uneven surfaces. In particular, the durometer—or hardness—of the elastomeric filler material may be selected dependent upon the usage of the article carrier.

As noted in connection with the previous embodiment, the outer wheel shell 24 shown in FIG. 4 may be rotationally or centrifugally molded rubber similar to wheels used on childrens' toys or model airplanes, and such molded rubber wheels may be filled with any of a number of types of resilient materials, including foam rubber, polyurethane foam, gel, or even the same material which is used to mold the tire shell 24.

Referring now to FIG. 5, there is disclosed an alternative embodiment of the invention wherein a tire shell 28 is filled with a foam rubber, gel-type, or other resilient filler material 30, the durometer—or hardness—of the filler material 30 being selected in dependence upon the shock absorption required for the particular application intended. For example, where ultra-sensitive instrumentation or delicate instruments are to be transported, the filler material 30 may be selected to be extremely soft, while the outer tire shell 28 may also be less soft. In applications where a limited amount of shock absorption capability may be required, the durometer of the filler material 30 of the elastomeric outer tire shell 28 may also be selected to provide similar limited shock absorption. Various combinations of differing durometers of the tire shell and the filler material may be used. In any event, the combination of the tire shell 28 and the inner filler material 30 provides extremely quiet rolling motion of the wheels 28 over relatively uneven hard surfaces. As noted, alternatively the filler material may be a gel-type material.

In each of the wheels of FIGS. 3-4, the tire shell is mounted on a hub 19 which is preferably made of nylon, but which can alternatively be made of other suitable alternative-materials. The hubs are mounted on axles 18 which are supported by brackets 17.

Referring now to FIG. 6, there is illustrated a cross-sectional view of an elastomeric tire shell 32 which is preferably rotationally molded, but which may be otherwise formed as by centrifugal or other molding process. The tire shell 32 contains an annular internal air space 34, preferably filled with air 36, either under one atmospheric pressure or at pressures greater than one atmosphere.

In FIG. 6, a pair of ball bearing units 38 containing a suitable plurality of bearing balls 40 and appropriate bearing races 42, 44 to promote smooth rolling operation are supported in hub 37 which is comprised of two halves, 39, 41. Hub halves 39, 41 are preferably made of nylon, but may alternatively be made of any other suitable material. The hub halves 39, 41 are appropriately dimensioned to be tightly fitted within the circular shaped central opening 46 in the tire shell, and the ball bearing units 38 are tightly fitted within circular appropriately dimensioned openings in the hub parts 39, 41 as shown. While the bearings are preferably made of known bearing metals, other suitable hard materials such as plastics may be used for the bearings 38 since the average loading with luggage is not anticipated to be substantial.

It has been found that the molded pneumatic tire and ball bearing combination shown in FIG. 6 will provide unique and smooth transport of a piece of luggage such as suitcase 10 shown in FIGS. 1-5 when mounted as shown in those Figs. The cushioning effect is provided by the cushion of air 36, combined with the resilience of the side walls 31, which in FIG. 6 are shown in a relatively thick configuration.

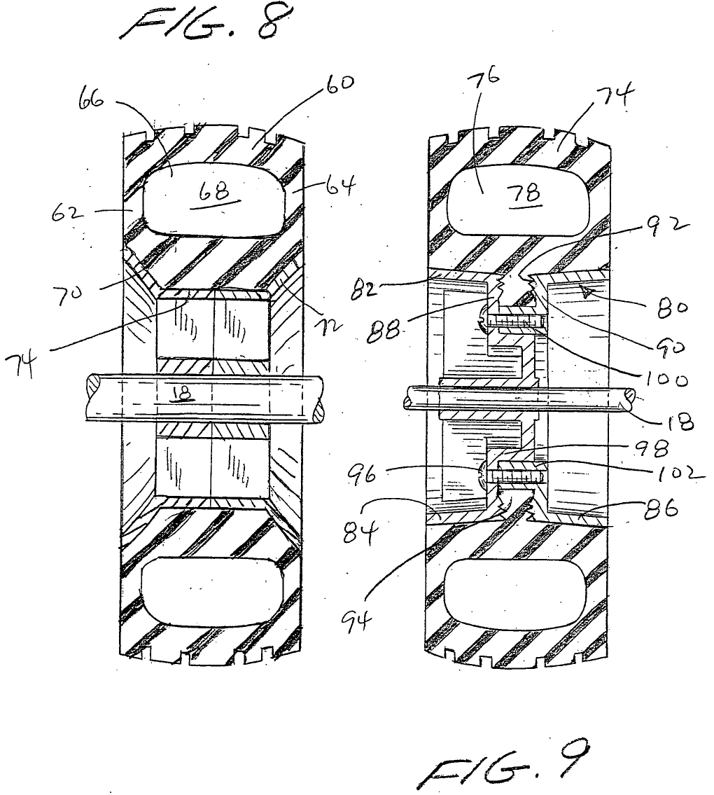

Referring to FIG. 7 there is shown a cross-sectional view of an alternative embodiment of the wheel of FIG. 6, incorporating a tire shell 48 having an internal space 50 filled with air 52 at one atmosphere or greater. The space 50 is of greater size than space 34 of the tire of FIG. 6 to provide greater cushioning in combination with sidewalls 54 which are of less thickness than the sidewalls 31 of the tire 32 of FIG. 6. In FIG. 7 a pair of central hubs 56, 58 are dimensioned and configured to fit one inside the other by a friction or press-fitted relationship with the tire shell openings on each side as shown. Hubs 56, 58 are also preferably of nylon, but may be made of metal or other suitable materials.

Referring now to FIG. 8, there is shown a cross-sectional view of yet another alternative embodiment of the wheel of FIGS. 6 and 7 in the form of tire shell 60 having side walls 62, 64 and an annular opening 66 filled with air 68. In this embodiment, a central hub is formed by two halves 70, 72 which are press or friction fitted directly into the central opening 74 of the tire shell 60 as shown. In this embodiment and that of FIG. 7, the press (or friction) fit relationship between the central hub halves 70, 72 and the tire shell 60 is satisfactory since, generally the load carrying requirements of a suitcase or similar articles are generally not significantly high. For example, a filled suitcase may weigh approximately 60 lbs. or less.

In the embodiments of FIGS. 6-8, a central axle 18 similar to axle 18 in FIGS. 1-5 will be positioned centrally of the hub as shown, to mount the wheels directly onto the luggage by suitable brackets similar to support brackets 17 shown in FIGS. 1-5. Further as an alternative embodiment, the tire shells shown in FIGS. 6-8 may also be filled with a gel-type resilient filler material or an alternative elastomeric filler material such as foam rubber.

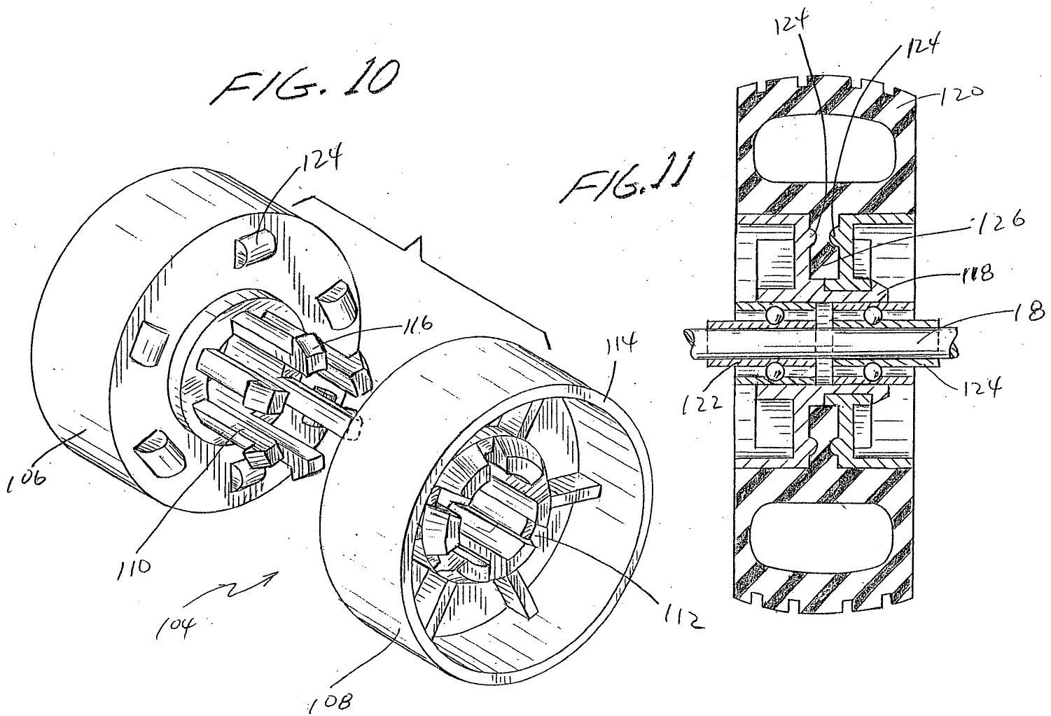

Referring now to FIG. 9, there is shown an alternative embodiment of the wheels of FIGS. 6-8, wherein rotationally molded tire shell 74 includes annular air space 76 filled with air 78, is mounted on two part hub 80, one half 82 being inserted into circular opening 84 on one side of tire shell 74, the other half 86 being inserted into circular opening 84 on the opposite side of tire shell 74 as shown. Hub halves 82, 86 are provided with radial walls 88, 90 which have roughened annular surfaces or are provided with concentric circular shaped sharp protrusions (shown in cross-section) intended to grip radially inwardly extending flange 94 which forms part of the tire shell 74. The hub halves 82, 86 are secured together by screws 96 which are inserted into circular openings 98 in hub half 82 and are threadedly received in mating female threaded openings 100 provided in a circular shaped flange 102 in hub half 86. Preferably, the hub halves are molded of nylon or other suitable material. Also, preferably six (6) screws 96 are arranged in a circular array around the tire opening. However, depending upon load requirements, four (4) or even more than six (6) screws may be provided.

Referring now to FIG. 10, there is shown a two part hub 104 similar to the nylon hub 80 of FIG. 9, except that hub halves 106, 108 are held securely together by a plurality of resilient fingers 110 extending axially from hub half 106 in a circular array similar to screws 96 of FIG. 9, and are received into openings 112 in hub half 114. Assembly of the hub halves is accomplished by inserting each hub half 106, 114 into a central circular opening of a tire shell such that bevelled surfaces 116 of fingers 110 initially engage a radial edge portion of hub half 114 and move radially inwardly until the hub half 106 is fully inserted and the fingers 110 move outwardly in snap-action fashion to fill the spaces 112 and give the appearance of a continuous circular flange 118 shown in FIG. 11. The hub halves 106, 114 are shown in assembled condition with a tire shell 120 in FIG. 11. Hub halves 106, 114 are preferably made of nylon or other resilient material and are dimensioned to receive ball bearing units 122, 124 which are similar to bearing units 38 shown in FIG. 6 and which are shown in FIG. 11. In FIG. 11, the bearings 122, 124 actually retain the Fingers 110 in the locked position to retain the hub halves together, since they cannot be flexed inwardly to release them unless the bearings are removed from the central openings.

Referring again to FIG. 10 and also to FIG. 11, hub halves 106,108 include barrel shaped arcuate protrusions 124 arranged in a circular array about the inner faces of the hub halves. The arcuate protrusions 124 are intended to grip radially inwardly extending flange 126 which is integrally molded as part of the tire shell to retain the hub and the shell in assembled relation.

It should be noted that the hubs of FIGS. 6, 10 and 11 can alternatively be dimensioned to receive an axle without use of the ball bearings, if desired.

Further, it should be noted that the tire cross-sections in the embodiments of FIGS. 1-5 differ from that of the embodiment of FIGS. 6-9 and 11 in that the first embodiment has a tire “footprint” of smaller radius than the radius of the footprint of the tire shells in FIGS. 6-9 and 11. The smaller radius would provide less resistance to movement over surfaces; however the greater radius, combined with the tire thread design shown in FIGS. 6-9 and 11 also provide ease of movement due in part to the combination of the tire lead with the ball bearing units. Each of the tire shell designs shown in the Figs. are preferred. However, alternative equivalent tire shapes are also contemplated.

It has been found that transporting an article of luggage over all types of terrain has been made simple and convenient even for individuals who are somewhat deficient in physical strength. In particular the smooth movement of the wheels combined with the cushioning effects of the air space and the resilience of the tire side walls render the movement smooth and simple. Further, when combined with the ball bearing units of FIG. 6, the smooth shock free movement of the article of luggage is unsurpassed by any known systems.

It should be noted that although an article of luggage has been illustrated, various other types or styles of article containers can be utilized with the present invention, provided that the inventive wheels disclosed herein are incorporated therewith. For example, as shown in the drawings, the article carrier—or container—14 shown in FIG. 1, is permanently attached to the support frame 17. Alternatively, the axle (or axles) 18 may extend directly through the luggage which may be reinforced to support the axle(s) and the total weight of the article of luggage and the contents.

1. An article carrier supported on at least two rotatably mounted wheels, each wheel comprising an elastomeric tire shell filled with a compressible material which permits resilient flexing of said outer tire, shell when said tire shell is rolled over relatively hard surfaces and engages relatively uneven abutments or the like.

2. The article carrier according to claim 1, wherein said compressible material is a gas under at least one atmosphere pressure.

3. The article carrier according to claim 2, wherein the gas is air.

4. The article carrier according to claim 3, wherein each said tire shell includes a valve device for introducing the air into a space defined by the tire shell.

5. The article carrier according to claim 1, wherein each said tire shell is filled with a resilient compressible elastomeric material.

6. The article carrier according to claim 1, wherein said compressible material is foam rubber or gel.

7. The article carrier according to claim 1, wherein each said tire shell is rotationally or centrifugally molded of a resilient synthetic or natural rubber material or combinations thereof.

8. The article carrier according to claim 7, wherein each said tire shell is molded of polyvinyl chloride (PVC).

9. The article carrier according to claim 1, wherein each said tire shell is rotatably supported on a hub to comprise a wheel, each wheel being supported on at least one axle, the axle supporting said article carrier.

10. The article carrier according to claim 9, wherein each said wheel is supported on the same axle.

11. The article carrier according to claim 1, wherein the article carrier is an article of luggage, computer case, or the like.

12. A wheel for supporting an article carrier such as an article of luggage, which comprises a rotationally molded elastomeric tire shell having an annular internal space filled with air at one atmosphere, said shell being securely mounted on a hub, said hub being comprised of two halves, a first hub half being inserted into a central opening of said shell from one side, and a second hub half being inserted into said central opening from the other side, means to secure said hub halves together in a manner to grip the tire shell so as to be fixed for rotation therewith.

13. The article carrier according to claim 12 wherein said means to secure said hub halves together comprise a plurality of threaded fasteners such as screws or bolts and nuts arranged in a circular array and extending from one of said hub halves to the other.

14. The article carrier according to claim 12 wherein said means to secure said hub halves together comprise a plurality of resilient extension fingers extending from one of said hub halves and having lock tabs at their free ends, said fingers adapted to be inserted into corresponding spaces in said other hub half to resiliently engage said other hub half in snap-action to retain said hub halves together.

15. The article carrier according to claim 14 wherein means is provided on said tire shell to be gripped by said hub halves to retain said hub halves in fixed assembled relation with said tire shell.

16. The article carrier according to claim 15, wherein said means on said tire shell to be supplied by said hub halves comprises an internal radially extending flange formed integral with said tire shell.

17. A shock-absorbing, quiet operating wheel for supporting an article of luggage, which comprises an elastomeric tire shell rotationally molded of polyvinyl chloride, said tire shell having an internal annular space filled with air, a hub including two hub halves, a first half having elongated resilient fingers adapted to be attached to a second hub half by resilient snap action, said hub having a central opening for reception of an axle to be positioned centrally of said hub to rotatably support said hub and said tire shell on an article of luggage.

18. A wheel according to claim 17, wherein said hub halves and said resilient fingers are molded of nylon.

19. A shock-absorbing, quiet operating wheel for supporting an article of luggage, which comprises an elastomeric tire shell rotationally molded polyvinyl chloride, said shell having an internal annular space filled with air, a hub including two hub halves, a first half being attached to a second hub half by a plurality of threaded fasteners, said hub halves having a central opening for reception of an axle to be positioned centrally of said hub to rotatably support said hub and said tire shell on an article of luggage.

20. The wheel according to claim 18 wherein said threaded fasteners are screws or bolts attached by nuts.
